(19) United States
(12) Patent Application Publication
(10) Pub. No.: US 2008/0138077 A1
(43) Pub. Date: Jun. 12, 2008

(54) Diverging Beam Optical Communication System

(76) Inventor: Stephen Stretton, Waipawa (NZ)

Correspondence Address: Mayer & Williams, 251 North Avenue West, 2nd Floor, Westfield, NJ, 07090, US

(21) Appl. No.: 11/666,470

(22) PCT Filed: Oct. 26, 2004
(86) PCT No.: PCT/IB04/03511

§ 371 Date: Nov. 29, 2007

(51) Int. Cl. H04B 10/00

(52) U.S. Cl. 398/130

(57) ABSTRACT

The invention refers to a diverging beam wireless network node including multiple bidirectional point-to-point links, which align between a central hub and dispersed clients. Assuming that the hub is limited in size, the receivers may be in close proximity to one another. In this case, the optical signal from two or more clients, which may have spread significantly in diameter due to angular spread in the transmitted light, may overlap spatially at the hub, causing interference and difficulty in separating the data. The invention solves the problems caused by such interference and permits communication links with low error rate.

### CROSS REFERENCE TO RELATED APPLICATIONS

The GB 2 377 570 is incorporated herein by reference as co-pending, co-assigned patent application related to the present invention. The person skilled in the art is able to gather detailed information from this earlier application regarding the construction of optical transmitters and optical receivers, which are useable for the present invention.

### FIELD OF THE INVENTION

This invention relates generally to short-range indoor and outdoor line of sight communication systems and specifically to an optical wireless communication system with multiple transmitter/receiver pairs.

### BACKGROUND OF THE INVENTION

Low cost, high bandwidth, wireless data communication is an urgent goal in a number of areas of application. Local area networks (LANs) require high bandwidth data communication, as do infrastructure data communications systems, such as telephony and video systems, including Internet applications. However, the time and expense of installing physical cabling or fiber between network or device nodes in many cases prohibits the practical installation or upgrading of systems. Other applications areas could emerge, once a low-cost high bandwidth data link is available.

RF wireless communication links have been utilized in the prior art. However, such links share bandwidth across multiple users in an area, provide access to the RF signal by all users and non-authorized persons resulting in security concerns, are subject to FCC regulations, and are practically limited to effective bandwidths per user which are much less than that of typical cabling and fiber optics. Open air, optical links have been utilized for data communications in the prior art. However, such links have typically suffered from high cost. One example of such a link uses a galvanometer type actuator for rotational control of an optical system. The optical system in such systems is typically a high precision lens structure mounted on a large, precision mechanical assembly. The resulting system is high performance and high quality, but bulky, expensive, difficult to install and has only a low speed or bandwidth for position adjustment, making it impractical for widespread use.

LASER/MEM's wireless communication links have been utilized in the prior art. However, such links suffer from (perceived) health and safety issues relating to the use LASERS. LASER light can be influenced by atmospheric phenomena, such as fog, rain, and snow, leading to attenuation of the signal in the communication line. It is also effected by deformations and slow vibrations of buildings and structures, where optical receivers and optical transmitters (emitters) are installed, resulting in a loss or partial reduction of the received signal level due to broken mutual pointing of the optical receivers and optical transmitters (emitters) of the opposite communication points. Nontransparent objects, e.g. birds, which can bring about sharp short-time weakening of the signal, can cross the communication lines. It can also be influenced by a position error and change of the beam angle of arrival to the optical receiver aperture during passage through the heat flows of the transparent turbulent atmosphere warmed by the sun, which can lead to fluctuations of the light capacity on the photodiode of the optical receiver that, under large amplitudes, can result in poorer communication quality. Open air, LASER based optical links have been utilized for data communications in the prior art. However, such links have typically suffered from high cost. Also greater degradation in performance due to scintillation, adverse weather conditions including fog and water vapor as well as building and structure movement and vibration, which take the beam out of alignment.

US 2002/0054412 describes an optical wireless communication system with multiple receivers and methods of preventing difficulties in separating the optical signals from two or more clients. The receiver field of view can be restricted and the receivers arranged so that the closest receivers have different fields of view. Narrow bandpass optical filters can be used and the receivers arranged so that the closest polarizers can be used on every other receiver. The receivers and/or transmitters can be time division multiplexed. Subcarriers of the optical carrier can be frequency modulated. An important feature of this system is the use of a controllable beam steering device, for instance a micro-mirror, which changes the direction of the light beam from the transceiver. However, such micro-mirror systems are expensive and susceptible for disturbances.

The object of the present invention is to provide an optical wireless communication system, especially for short distance connections. The system should be adapted to different distances between receiver and transmitter. It should not need any mirror optics, prisms or deflection components in order to change the direction of the light beam from the transceiver. Moreover it is an object of the invention to provide for an optical wireless system, which remains in aligned condition as long as the position of receiver and transmitter is in a predetermined area.

### SUMMARY OF THE INVENTION

A diverging beam wireless network node according to the present invention includes multiple bi-directional point-to-point links, which align between the central hub and dispersed clients. Assuming that the hub is limited in size, the receivers may be in close proximity to one another. In this case, the optical signal from two or more clients, which may have spread significantly in diameter due to angular spread in the transmitted light, may overlap spatially at the hub, causing interference and difficulty in separating the data.

The field of view of each receiver from the plurality of receivers arranged within the hub is restricted, as to be aligned with the transmitter view or beam by orientating the field of view of each receiver of the hub different from the field of view of the neighboring receiver.

The signal strength at each receiver from the corresponding aligned transmitters is controlled by varying the beam spread of the transmitter as a function of distance between the receiver.

Design specifications for a new stop system has been incorporated to improve the efficiency of the receiver upon the system specifications in co-patent GB 2 377 570. This is most beneficial for long range outdoor solutions.

Requirement for transmitter (Tx) and receiver (Rx) to be in a minimum distance of 30 cm apart has been eliminated in the system design according to the present invention (differing from GB 2 377 570). This allows for the development of a compact system for indoor deployment.

### BRIEF DESCRIPTION OF THE DRAWINGS

The above features of the present invention will be more clearly understood from consideration of the following descriptions in connection with accompanying drawings in which:

FIG. 1 is an overview of an indoor optical wireless network;

FIG. 2 is an overview of an outdoor optical wireless network;

FIG. 3 is a block diagram of an optical wireless modem according to a preferred embodiment of the present invention;

FIG. 4 shows preferred embodiments for the transmitter of an optical module dependant on deployment distance between transmitter-receiver-pairs (Tx/Rx);

FIG. 5 shows preferred embodiments for the receiver of an optical module dependant on deployment distance between Tx/Rx pairs;

FIG. 6 shows different positions of one or two stops used in the receiver;

FIG. 7 is a block diagram of an optical wireless network with multiple transmitters and receivers per Tx/Rx pair;

FIG. 8 shows an intrusion detection barrier using an array of diverging beam systems.

### DETAILED DESCRIPTION OF ILLUSTRATIVE EMBODIMENTS

The making and use of the various embodiments are discussed below in detail. However, it should be appreciated that the present invention provides many applicable inventive concepts, which can be embodied in a wide variety of specific contexts. The specific embodiments discussed are merely illustrative of specific ways to make and use the invention, and do not limit the scope of the invention.

The embodiments of the present invention will now be described with reference to the drawings.

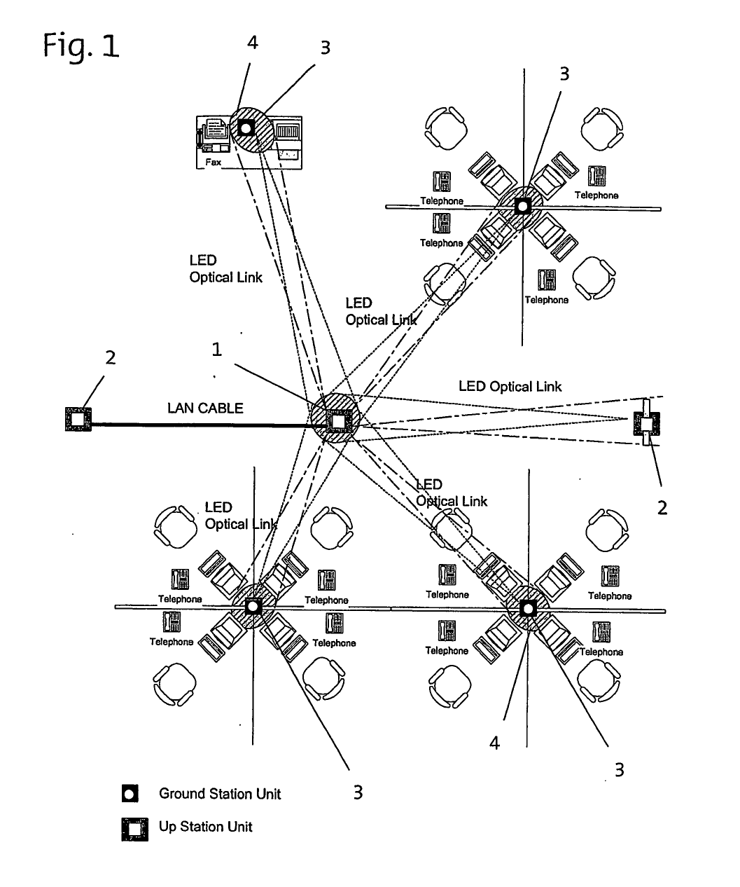

FIG. 1 shows an overview of a potential indoor network application of the present invention. Description of a number of implementations then follows. Referring now to FIG. 1, the deployment of an indoor optical network includes a first Distribution Hub 1, which could be connected to other distribution hubs or conventional hubs 2 either optically via Diverging Beam LED Optical Link, LASER/MEM Optical Link or physical LAN cabling to form a network backbone. The advantages of the different connections are due to the type of network already in place in a building. If the building is wired with CAT5 cable (Category 5 cable) it can be connected directly via cable to the unit. There is also the capability of interfacing fibreoptic cable directly to the distribution hubs. The distribution hubs can also be connected with each other by using Laser diodes in place of LED's. It shows the opportunity of using a standard LASER link, which is not MEM based, for routing high Bandwidth across the ceiling. Recapitulatory it is to be marked that the inventive system can be deployed in existing buildings and is not necessarily a stand-alone system.

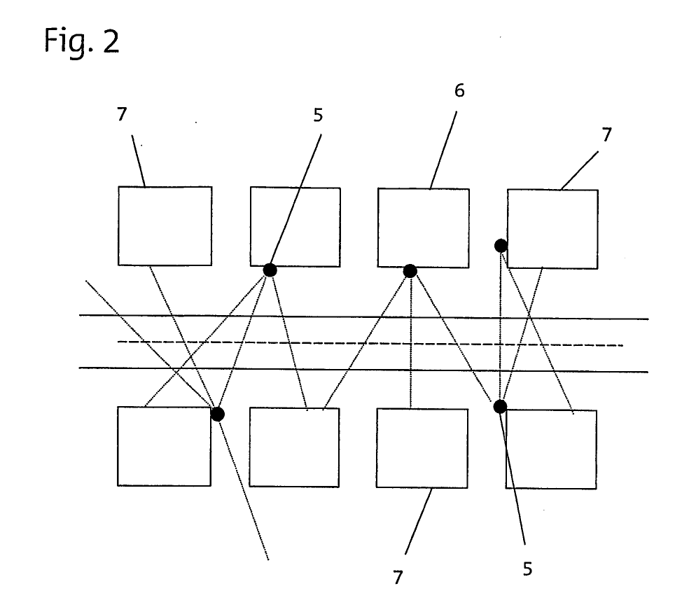

These issues of connectivity can also be used for outdoor units connecting buildings up a street (FIG. 2).

The Distribution Hub 1 is also connected to a plurality of Ground Hubs 3. The Distribution Hub 1 and the Ground Hubs 3 have transmitter/receiver (Tx/Rx) pairs for each link between Distribution Hub and Ground Hub as to provide bi-directional communication links. The Distribution Hub Tx/Rx pairs are independently aligned to transceive optical signals from the Ground Hub 3 Tx/Rx pairs, which are independently located where service is required.

As to be seen from FIG. 1, the light beams emitted by the transmitter cover a wide receiving area 4 around the receivers, which are symbolised by the hatched areas. Especially for beam steering for alignment as the wide beam keeps the system in alignment. Thus, the receiver Rx can be easy positioned within said receiving area without the risk of loosing the aligned condition. Because of the use of diverged beams the communication system does not suffer from interference due to vibrations etc.

From FIG. 1 it can be seen that the Ground Hubs 3 would usually consist of one-to-n ports for the connection of network enabled components through Universal Serial Bus (USB) and RJ45. Infrared, Bluetooth, WI-LAN and other connectivity technologies are also feasible and included within this invention.

The use of Bluetooth is favourable in connection with the generation of wireless hotspots. For instance a hotspot with a radius of 10 m can be created by using Bluetooth whereby interferences can be avoided. There are already cases where WIFI (wireless fidelity) hotspots are interfering with each other.

FIG. 2 shows an overview of an outdoor optical wireless network. The network includes a plurality of Outdoor Distribution Hubs 5, which are built for an outdoor environment for MESH and other network configurations. It is envisioned in one deployment topology that main house 6 on a street could have an incoming T1 line or other communications link from a service provider and could share this bandwidth with local neighborhood houses 7 through a low cost, high availability, low maintenance Wide Area Network (WAN). The Outdoor Distribution Hub 5 consists of several ports for service connectivity into the building it is attached to. An optical repeater, which effectively consists of back-to-back transceivers, can be utilized for large distance links and to avoid objects, which block the line of sight.

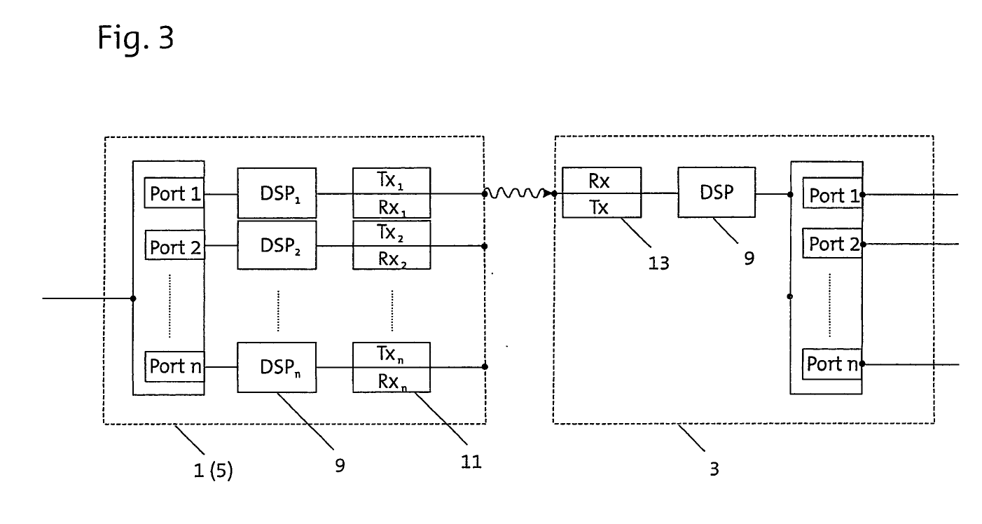

FIGS. 3, 4, 5 will now be used to describe a preferred embodiment of a communications device such as would be found at either or all of Hubs 1, 3, 5:

One embodiment of a hub module includes a pair of transceiver circuits 11, which converts electrical signals to light pulses and vise versa to and from a digital signal processor 9 (DSP). The transmitter contains as its light source a high power LED that is eye safe and a corresponding photo-detector with amplification to match the input requirements of the DSP unit.

The multiple DSP units 9 with their corresponding transceiver pairs 11 connect into a hub containing “one to many” ports in the case of above-mentioned Hubs 1 and 5. For the Ground Hub 3 there is a transceiver pair 13, which connects the Ground Hub optically with its Distribution Hub 1 or 5. Further, the Ground Hub 3 comprises a series of ports available for the networking of peripheral devices, not limited to PC, printer, fax, wireless devices etc.

The transmitter light source is a LED 15. It is an incoherent light source, which unlike a LASER has no perceived health and safety issues.

The inventive ability to adjust the beam diameter to the Rx enables the system to reduce the effects of a weakening of the signal strength over large distances and limits interference from alternate light sources.

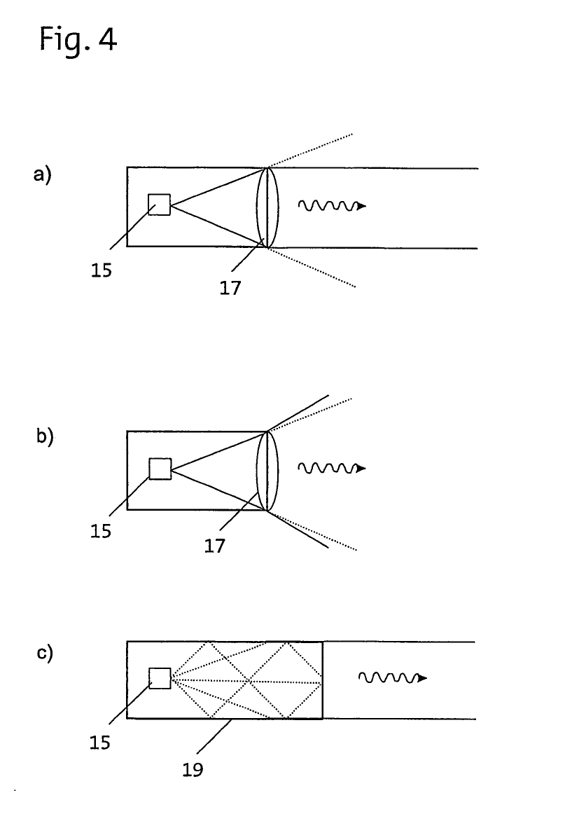

FIG. 4 shows embodiments using optics to modify the divergence of the light beam from the Tx LED 15. This can either be expanded or converged dependant on the distance to the Rx, which allows for constant signal strength to the Rx (over varying distances). One embodiment allows for compound optics to achieve the same objective.

FIGS. 4a) and b) show the Tx LED 15 modified by optics 17 to converge or diverge. FIG. 4c) shows the Tx LED 15 in a tube 19 without additional optics and where the position of the Tx LED 15 limits the spread of the beam by collision on the walls of the tube 19. It must be noted that this configuration is inefficient and results in lost of signal strength. However, for short distance communication links this cheap embodiment is sufficient.

It should be noted that the main object of the modification of the emitted light beam is to influence the signal strength. The signal strength received by the receiver Rx shall be essentially constantly. Therefore, the divergence of the light beam is high for a short distance between Tx and Rx and shall be low for a longer distance between Tx and Rx. For instance the cone of light could be set to a diameter of 1 meter at the plane of the receiver Rx independently of the distance from transmitter Tx. Consequently the signal strength will be nearly the same as long as the receiver is positioned within the cone of light.

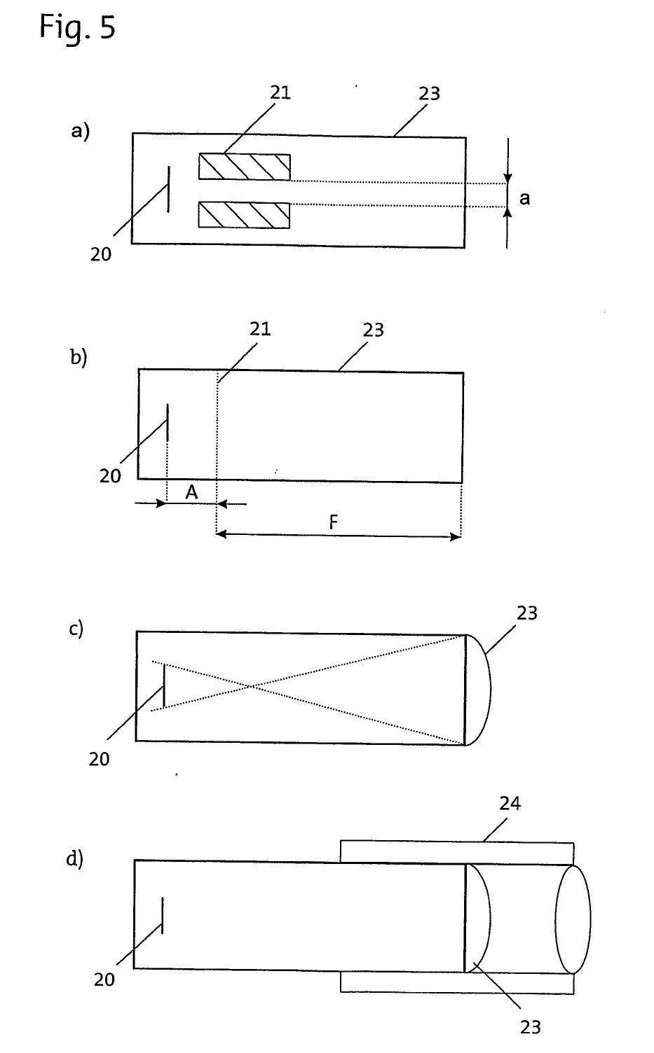

FIG. 5 shows preferred embodiments for the optical receiver of an optical module dependent on deployment distance between Tx/Rx pairs. The receiver includes a photodiode 20 or another suitable photo-detector. The embodiments of FIGS. 5a) and b) use a special optical scheme for each of the optical receivers. This type of scheme is known from the incorporated document GB 2 377 570 A but has been modified according to the present invention to significantly improve the characteristics of the stop within the receiver. To reduce the density of the incident light flow on the photodiode surface, and, consequently, to increase the operation resource of the LED, an optical stop 21 (aperture) or a multiplicity of stops are installed in the focal plane of the lens 23, forming the visual angle of the optical receiver, the so called beam angle.

Where tan θ=a/2Fₐ
a—diameter of the stop aperture,
Fₐ—distance from focal point to position of the stop,

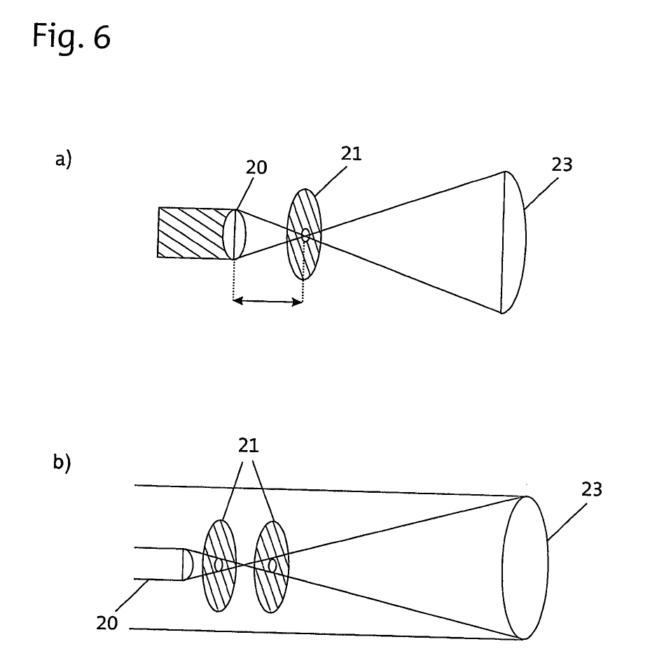

Possible locations of the stop 21 are better to be seen in FIG. 6 showing the beam path in a receiver Rx. In each case, the photodiode 20 is located behind the focal point at distance A. The stop 21 is positioned in the focal plane of the optical condenser (FIG. 6a) either in front or behind the focal point or in both positions (FIG. 6b) providing for reduced density of the light flow falling on the photodiode 20 from other light sources (sun light, reflected light etc without reducing the value of the light capacity of said flow from the related transmitter. Therefore, the first optical receiver of each of said transceivers is made in the form of consecutively installed and optically connected optical condenser, stop and photodiode. The distance A between the photodiode 20 and the focal point located in the focal plane of the optical condenser is defined by the formula

A=bF/D_{c},

where
b—diameter of the light-sensitive site of the photodiode,
D_{c}—diameter of the optical condenser lens.

The input of the optical condenser being the input of the optical receiver of each of said transceivers, and the output of the photodiode being the output of the first optical receiver of each transceiver.

Returning to FIG. 5, the optical signal strength at the receiver is defined by the amount of transmitted light that is adsorbed by the receiving photodiode. The effective collection area of the receiver is sometimes increased by use of concentrating optics as shown in FIG. 5c), e.g. imaging lenses or non-imaging optics, that also inherently limit the receivers field of view. FIG. 5d) shows an embodiment, where the field of view is limited by including blocking optics such as a tube 24.

To increase the separation distance between receivers that could detect incoming light from clients in nearly the same direction from the Distribution Hub 1, the field of views of receivers in closest spatial proximity can be pointed in different directions such that their fields of views do not overlap. This increases the spatial separation between receivers with overlapping field of views. This is illustrated in FIGS. 1 and 2.

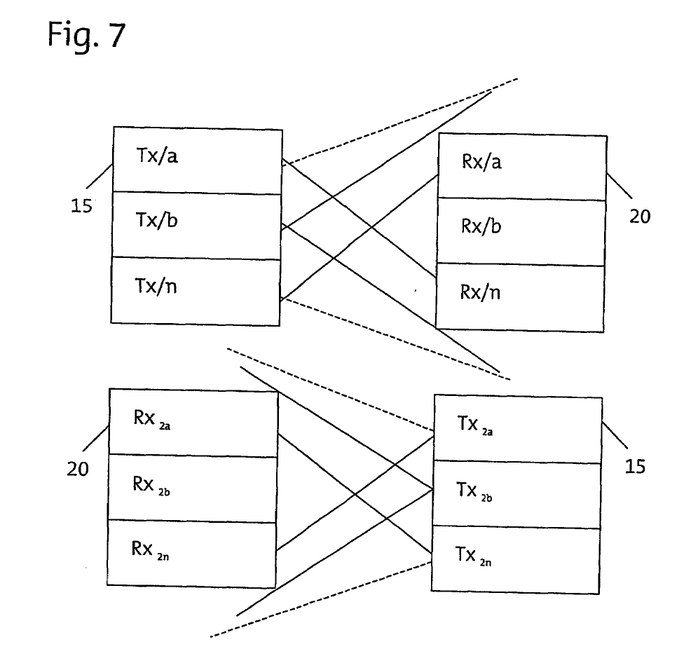

FIG. 7 displays an array whereby Tx is a collection of multiple transmitter LED's 15 simultaneously transmitting the same signal and Rx is an array of photodiodes 20 simultaneously receiving the same signal. The effect of this embodiment is that the signal strength is increased and there are a multiple of transmission paths, which increases the reliability of the transmission, which can be effected by atmospherics, e.g. smoke in an office or water particles etc. The multiple receivers also increase reliability.

Another embodiment, not shown in the figures, uses polarization of the light beams to reduce interference by incidental light, though it must be noted that this also effects the signal strength. Light can be polarized such that the waves lie in one direction. When the light passes through a polarizer with its polarization parallel to the light polarization, the light is passed. When the light passes through a polarizer with its polarization perpendicular to the light polarization, the light is blocked.

For establishing of a transmission system, especially for alignment of the system, different methods could be used, either by tracking the signal strength or via visible methods such as LASER pointer to align the system. One embodiment of the system is to utilize a high strength LED that uses infrared radiation for data transmission but has high signal strength in the visible red spectrum whereby the visible light is used to align the Tx/Rx pairs. This light can also be used to verify that there is no signal overlap with other Tx/Rx pairs.

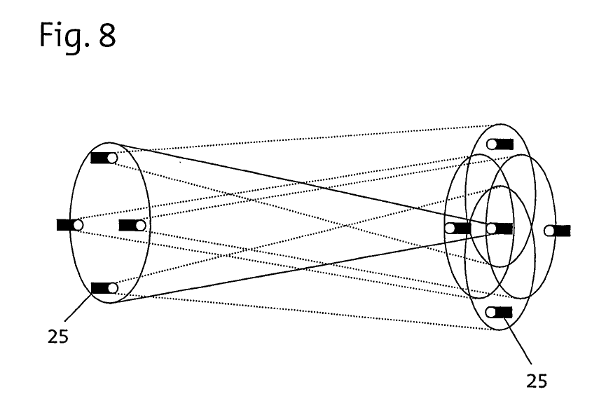

FIG. 8 shows an intrusion detection barrier using an array of diverging beam systems. Two arrays of Tx/Rx pairs 25 are positioned spatially apart and aligned over short or long range. The diverging beam from a transmitter Tx is detected simultaneously by a multitude of receivers Rx in the distance. The diverging beam from more than one Tx can be detected by an array of receivers Rx. The pattern of lost bits at each Rx caused by the blocking of the beam allows for the calculation of the size and dimensions and velocity of the object as well as the distance between the Tx and corresponding Rx array where the intrusion occurred. This is achieved by the spatial positioning of the Tx/Rx arrays and triangulation and offers more technical benefits over Laser based systems. Signal processing allows for the determination of the object characteristics and is capable of detecting simulation events along the beam path due to the capability of being able to detect intrusion distance.

The system showed in FIG. 8 can be deployed in all security situations. It can be connected to control surveillance cameras and CCTV (Closed-circuit television) in urban or remote locations including border control passing alerts and triggering response mechanisms to the correct point of incursion.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

### LIST OF REFERENCES

1 Distribution Hub
2 Conventional Hub
3 Ground Hub
4 Receiving area
5 Outdoor Distribution Hub
6 Main House
7 Neighborhood Houses
9 Digital Signal Processor
11 Transceiver Pair of a distribution hub
13 Transceiver Pair of a ground hub
15 LED
17 Optics for converging or diverging
19 Tube
20 Photodiode
21 Stop
23 Lens
24 Tube of receiver module
25 Transmitter/receiver pair

1. An optical wireless communication devices comprising:
a first optical receiver having a photo-detector with a first field of view and for receiving first data from a first remote source;
a second optical receiver having a photo-detector with a second field of view and for receiving second data from a second remote source, whereby the second field of view is out of line with the first field of view; and
a processing circuit coupled to the first and to the second optical receivers such that each remote source has an optical transmitter generating a diverging beam of light, and means to expand or contract the beam to both modify the signal strength as a ratio to distance and to assist in physically aligning and focusing one of said optical receivers without substantially deflecting the beam of light.

2. The device according to claim 1, wherein said optical transmitter is a high power LED which is physically aligned with the photo-detector of one of said optical receivers.

3. The device according to claim 1, further comprising a plurality of optical receivers, each having a photo-detector with a predetermined field of view.

4. The device according to claim 3, wherein different ones of the optical receivers are aligned to have different fields of view such that each incoming optical beam can be viewed by at most one receiver.

5. The device according to claim 1, wherein different ones of the optical receivers having different fields of view are aligned such that each incoming optical beam cannot be viewed at the same time by two adjacent receivers.

6. The device according to claim 1, wherein different ones of the optical receivers are aligned so that no receivers within a certain area have coincident fields of view such that each incoming optical beam cannot be viewed by any two receivers in said area at the same time.

7. The device according to claim 1, wherein the processing circuitry comprises a media converter, hub or bridge.

8. The device according to claim 1, wherein at least one of the optical receivers further comprises an optical condenser and at least one optical stop that is located between the condenser and the photo-detector, such that the density of the incident light flow on the photo-detector is reduced.

9. The device according to claim 8, wherein the photo-detector is located behind the focal point of the condenser and the stop is positioned in the focal plane of the condenser, in front or behind the focal point, or in both positions.

10. The device according to claim 1, wherein at least one of the optical receivers further includes a polarization filter.

11. The device according to claim 1, wherein at least one of the optical receivers further includes a wavelength filter.

12. The device according to claim 1, wherein each optical receiver includes a plurality of photo-detectors aligned with a plurality of LED's.

13. The device according to claim 1, wherein the optical receiver includes an array of receivers, which are aligned with one optical transmitter or with an array of transmitters of the accompanying remote source, and wherein the processing circuit calculates an intrusion of the diverging beam from a triangulation detected by the array of receivers.

14. A method of communicating with a optical wireless signal, comprising:
receiving a first optical wireless signal at a first angle from a first remote source;
receiving a second optical wireless signal at a second angle that is different than the first angle from a second remote source; and
distinguishing between the first optical wireless signal and the second optical wireless signal.

15. The method according to claim 14, further comprising physically aligning each optical receiver with its reciprocal remote source during an installation routine by using visible light.

16. The method according to claim 14, wherein intrusion of a diverging beam of the optical wireless signal is detected by utilizing an array of optical transmitter/receiver pairs, wherein a subsequent signal processing is used to determine the dimensions of an intrusion object.
